(19) United States
(12) Patent Application Publication
(10) Pub. No.: US 2003/0068068 A1
(43) Pub. Date: Apr. 10, 2003

(54) Content based digital watermarking using wavelet based directionality measures

(76) Inventors: Nam-Deuk Kim, Sherwood, OR (US); Alastair M. Reed, Lake Oswego, OR (US)

Correspondence Address: DIGIMARC CORPORATION, 19801 SW 72ND AVENUE, SUITE 100, TUALATIN, OR, 97062, US

(21) Appl. No.: 09/967,913

(22) Filed: Sep. 28, 2001

(51) Int. Cl. G06K 9/00

(52) U.S. Cl. 382/100

(57) ABSTRACT

A perceptual masking method for digital watermarking identifies areas of dominant orientation within an image and modifies the watermark gain for those regions. The perceptual masking model computes local contrast and measures directionality of image features in small neighborhoods using a standard wavelet filter set and a rotated wavelet filter set to determine if the regions are highly oriented in one direction. The watermark strength gets suppressed if the corresponding area has high contrast and high directionality measure, while the gain reaches the maximum when the area has high contrast and low directionality measure.

### RELATED APPLICATION DATA

This patent application is related to U.S. patent application Ser. No. 09/737,609 filed Dec. 13, 2000, which is a continuation in part of 09/596,658, filed Jun. 19, 2000. These patent applications are hereby incorporated by reference.

### TECHNICAL FIELD

The invention relates to steganography, data hiding, and digital watermarking.

### BACKGROUND AND SUMMARY

Digital watermarking is a process for modifying physical or electronic media to embed a machine-readable code into the media. The media may be modified such that the embedded code is imperceptible or nearly imperceptible to the user, yet may be detected through an automated detection process. Most commonly, digital watermarking is applied to media signals such as images, audio signals, and video signals. However, it may also be applied to other types of media objects, including documents (e.g., through line, word or character shifting), software, multi-dimensional graphics models, and surface textures of objects.

Digital watermarking systems typically have two primary components: an encoder that embeds the watermark in a host media signal, and a decoder that detects and reads the embedded watermark from a signal suspected of containing a watermark (a suspect signal). The encoder embeds a watermark by altering the host media signal. The reading component analyzes a suspect signal to detect whether a watermark is present. In applications where the watermark encodes information, the reader extracts this information from the detected watermark.

Several particular watermarking techniques have been developed. The reader is presumed to be familiar with the literature in this field. Particular techniques for embedding and detecting imperceptible watermarks in media signals are detailed in the assignee's co-pending application Ser. No. 09/503,881 and U.S. Pat. No. 6,122,403, which are hereby incorporated by reference.

The invention provides a method of perceptually masking a digital watermark signal in an image signal. This method computes wavelet transforms of the image, each at different angular orientations. It then evaluates the output of the wavelet transforms to compute a directionality measure of features in the image. Using this directionality measure, the method modifies the embedding strength of the digital watermark signal for locations within the image to minimize perceptibility of the digital watermark and enhance its detection.

In one implementation, a perceptual masking method for digital watermarking identifies areas of dominant orientation within an image and modifies the watermark gain for those regions. The perceptual masking model computes local contrast and measures directionality of image features in small neighborhoods using a standard wavelet filter set and a rotated wavelet filter set to determine if the regions are highly oriented in one direction. The watermark strength gets suppressed if the corresponding area has high contrast and high directionality measure, while the gain reaches the maximum when the area has high contrast and low directionality measure.

Further features will become apparent with reference to the following detailed description and accompanying drawings.

### BRIEF DESCRIPTION OF THE DRAWINGS

FIG. 1 is a diagram illustrating a content-based digital watermarking method for still and moving images that employs a wavelet based directionality measure.

FIG. 2 is a diagram of a rotated wavelet transform, which is used to calculate directional information at this rotated angle in an image.

FIG. 3 illustrates an example showing how directionality based perceptual modeling reduces visibility of the digital watermark signal along image edge features.

### DETAILED DESCRIPTION

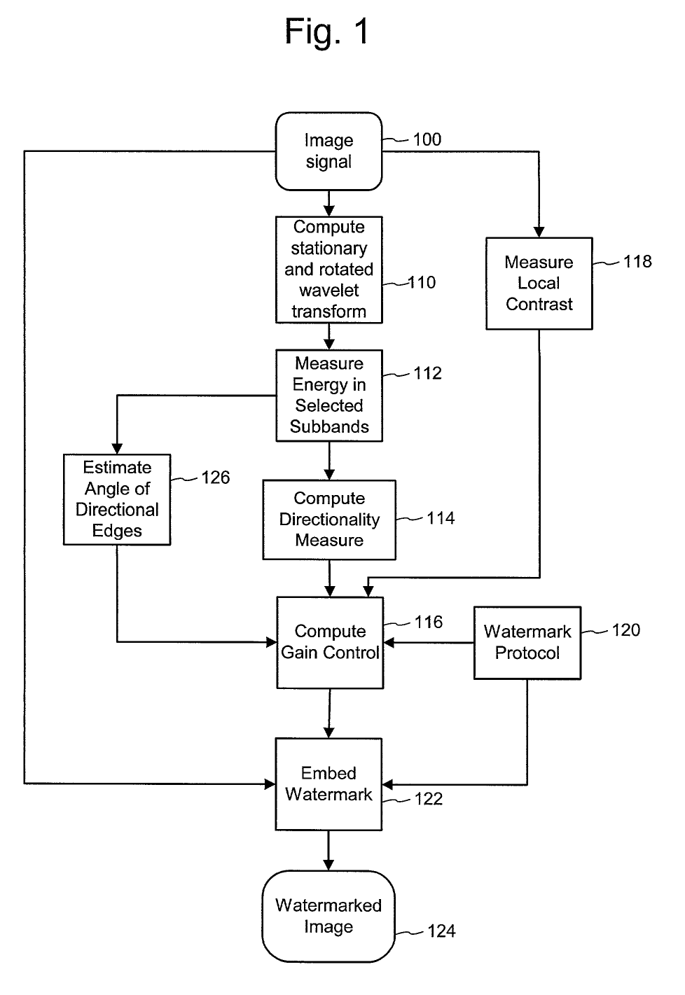

FIG. 1 is a diagram illustrating a content-based digital watermarking method. The input to the method is a digital image signal 100. The signal may be segmented into blocks and processed one block at a time (e.g., 256 by 256 blocks in a video frame or still image). The method operates on spatial domain image samples in a particular color channel or channels (e.g., luminance or chrominance).

The method computes a series of wavelet transforms of the image block. In one implementation, this process includes a stationary wavelet transform and a rotated wavelet transform (110). Each wavelet transform has three filters to generate LH, HL, and HH subband images as the same spatial resolution as the input image. The rotated wavelet transform, as explained further below, has a particular angular orientation, such as 45 and 135 degrees. The stationary wavelet transform is not rotated, and as such, represents orientation information at 0 and 90 degrees. Additional rotated wavelet transforms at other angular orientations may be used as well.

In one implementation, the wavelet transform comprises 2 dimensional Haar wavelet filters. These filters are represented by the following expressions:

$${H}_{l l} = \frac{1}{2} [ \begin{matrix}1 & 1 \\ 1 & 1\end{matrix} ] , {H}_{h l} = \frac{1}{2} [ \begin{matrix}- 1 & - 1 \\ 1 & 1\end{matrix} ]$$

$${H}_{l h} = \frac{1}{2} [ \begin{matrix}- 1 & 1 \\ - 1 & 1\end{matrix} ] , {H}_{h h} = \frac{1}{2} [ \begin{matrix}- 1 & 1 \\ 1 & - 1\end{matrix} ]$$

Preferably, the wavelet transform should be shift invariant (i.e. stationary). This enables the filter to effectively measure image texture features because a texture in an image is usually considered to be shift invariant.

Another attribute of the wavelet transforms used in the implementation is the ability to characterize texture features at different orientations. Standard wavelet transforms decompose 2D images into horizontal (LH), vertical (HL) and diagonal orientations (HH). The diagonal direction in a standard wavelet transform does not provide useful information about directional characteristics because it represents the features along the 45 and 135 degree angles of rotation simultaneously. Wavelet filters that are potential candidates for characterizing orientation include Gabor filters, hexagonal wavelet transforms, and steerable wavelet transforms.

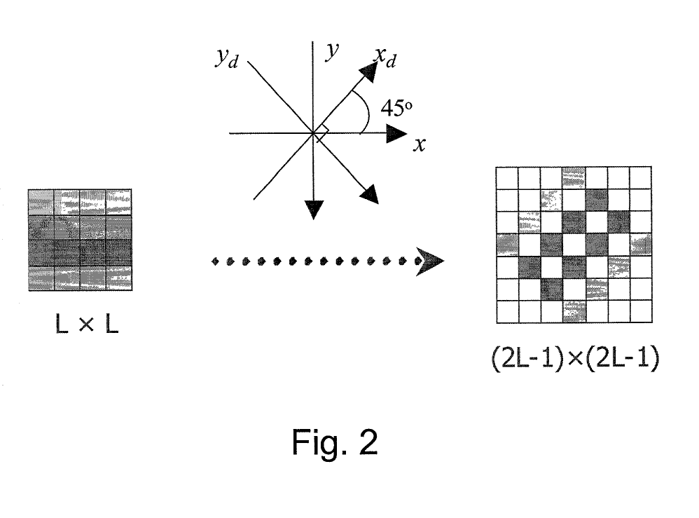

The implementation characterizes image features at different orientations by rotating 2D wavelet filters by a desired angle of rotation, such as 45 degrees. FIG. 2 illustrates an example of this type of rotated wavelet filter. A standard 2D wavelet filter shown on the left side of FIG. 2 is rotated by 45 degrees to create a rotated filter. The dimensions of the filter increase from L by L to 2L-1 by 2L-1 to accommodate the rotation. The spatial elements not covered by the rotated filter are zero padded. By rotating the filter in this way, the resulting filter characterizes directional information along the angle of rotation of the filter.

For more on rotated wavelet filters, see Nam-Deuk Kim and Satish Udpa, “Texture classification using a rotated wavelet filterbank”, IEEE Transactions on System, Man, and Cybernetics, Vol. 30, No. 6, pp.847-852, 2000, which is hereby incorporated by reference.

Returning to FIG. 1, the method measures energy in selected subbands of the stationary and rotated wavelet transforms to characterize the image energy along different orientations (112). In particular, it measures the energy in the LH, HL, and HH subbands for overlapping pixel blocks (such as 8 by 8 or 6 by 6 pixel blocks) in the subband images. The expression for energy is:

$${ϵ}_{k} = \frac{1}{M N} {\sum }_{m}^{M - 1} {\sum }_{n}^{N - 1} {‖ {y}_{k} ( m , n ) ‖}^{2}$$

The method computes the energy for locations within the image by convolving the energy filter with the subband samples produced from the wavelet filters. The energy in a particular block provides a measure of the directional edges along a particular orientation as shown in the following Table 1:

TABLE 1

| | | Orientation of Directionality |
|---|---|---|
| | | Measure (in degrees), where 0 = |
| Wavelet Filter | Subband | horizontal |
| Stationary | LH | 0 |
| Stationary | HL | 90 |
| Rotated | LH | 45 |
| Rotated | HL | 135 |

The method computes a directionality measure based on an analysis of the relative energies of corresponding blocks in the LH and HL subbands for each wavelet transform (114). As the image becomes more directional along a particular orientation, the energy differential for the subbands corresponding to that orientation increases. For each location within the image, the method computes the difference in energies of the LH and HL subbands for the subband samples at that location from the stationary wavelet filter. It repeats this process for the energies of the LH and HL subbands for the rotatated wavelet filters. The difference in energies of the subbands provides a measure of the directionality of the image in a particular orientation. In particular, the difference in energies of the HL and LH subbands of the stationary wavelet transform indicate whether there are strong vertical or horizontal edges, while the difference in energies of the HL and LH subbands of the rotated wavelet transform indicate whether there are strong diagonal edges. The sum of these differences provides a composite directionality measure.

An expression for this type of directionality measure is:

$${F}_{D M}^{i} = {[ \frac{D ( {ϵ}_{{C}_{H L}^{i}} , {ϵ}_{{C}_{L H}^{i}} )}{{F}_{S S E}^{i}} ]}_{S WFB} + {[ \frac{D ( {ϵ}_{{C}_{H L}^{i}} , {ϵ}_{{C}_{L H}^{i}} )}{{F}_{S S E}^{i}} ]}_{R WFB}$$

where:

D(a,b)=|a−b|

In the above expression, the energy differential for each term is normalized by dividing by an image energy measure, the sum of energies of LH, HL, and HH subbands. The method computes a directionality measure for each location within the image.

This directionality measure is then used as one input for computing a gain control (116), which controls the strength of the digital watermark signal to be hidden in the image. The gain control comprises a two dimensional array of elements corresponding to locations within the image. The values of these elements control the strength of the watermark signal at the corresponding spatial image locations within the host image. The gain control may be dependent on a number of other inputs, such as a local contrast measure of the image (118), and the watermark protocol (120), which specifies the type of watermark signal to be embedded. One type of watermark signal is a pseudo random signal produced by spread spectrum modulating a message signal. The watermark signal need not be entirely random. For example, the digital watermark embedder may derive it by modulating features of the host image signal.

In one implementation where the watermark is characterized as a pseudo random texture image, the directionality measure is used to suppress the strength of the watermark signal more so in areas where the directional edge measure is higher. To accomplish this, the gain control reduces the gain of the watermark signal as a function of the directional edge measure. This suppression of the watermark signal reduces the noise distortion introduced by embedding the digital watermark along directional edges. When used in conjunction with a measure of local contrast, the directionality measure forms part of a perceptual masking process that increases the watermark signal strength in areas where the measure of local contrast indicates a highly textured image feature, and decreases the watermark signal strength in areas where the directionality measure indicates a directional edge feature.

There are a variety of image filters suitable for measuring local contrast. Examples include measuring signal energy, measuring high frequency content (e.g., high pass filtering), performing edge detection and measuring density of edges, measuring variance, measuring difference of pixel values from average of local neighborhood of pixels, etc. Such techniques are discussed in the patent and patent applications incorporated by reference as well as other watermarking literature.

The embedder embeds the digital watermark in the host image using the gain control to adapt the strength of the watermark signal to the perceptual attributes of the image. Namely, the strength of the watermark signal is reduced where the directional edge measure is higher. The result is a watermarked image 124, where the digital watermark is more effectively hidden.

As noted, the wavelet filters may also be used to estimate the angle of the directional edges in an image. This estimate of the angle of directional edges may be used to selectively increase the energy of a digital watermark signal along edges where that edge provides a perceptual masking of the watermark signal. For example, for digital watermark signal defined in the frequency domain, such as a signal that increases or decreases the frequency magnitude of the image at selected frequencies, the estimate of the angle of directional edges may be used to increase the strength of the frequency domain watermark along the angle of the dominant edge.

In one implementation, the watermark signal includes a frequency domain component with peaks at selected frequency coefficients. In particular, it has peaks at selected locations in the Fourier magnitude space of the image. In this implementation, the energy measured in the subbands as shown in block 112 is used to estimate an angle of dominant directional edges in the image as shown in block 126. As described above, the energy measurements in the LH and HL subbands for stationary and rotated wavelet transforms provide a directionality indicator. This directionality indicator provides an estimate of the direction of directional edges. This directionality indicator serves as an additional input to the gain control, where the signal strength of the digital watermark is increased in the frequency domain along the orientation of a directional edge.

The methods described above evaluate oriented texture regions within an image signal and perceptually adapt watermark signals for these regions. This perceptual modeling enables the watermark to be encoded with more energy in areas where the data hiding attributes of the oriented texture are higher. This enables a better detection rate of the digital watermark in image signals. In addition, the perceptual modeling selectively reduces the watermark signal energy to improve visual quality of the watermarked image, and reduce the perceptibility of distortions due to the watermark signal, such as visual artifacts along directional edges. The wavelet filters illustrated in the embodiments above are efficient, and thus, do not create an adverse impact on computational complexity or resource usage.

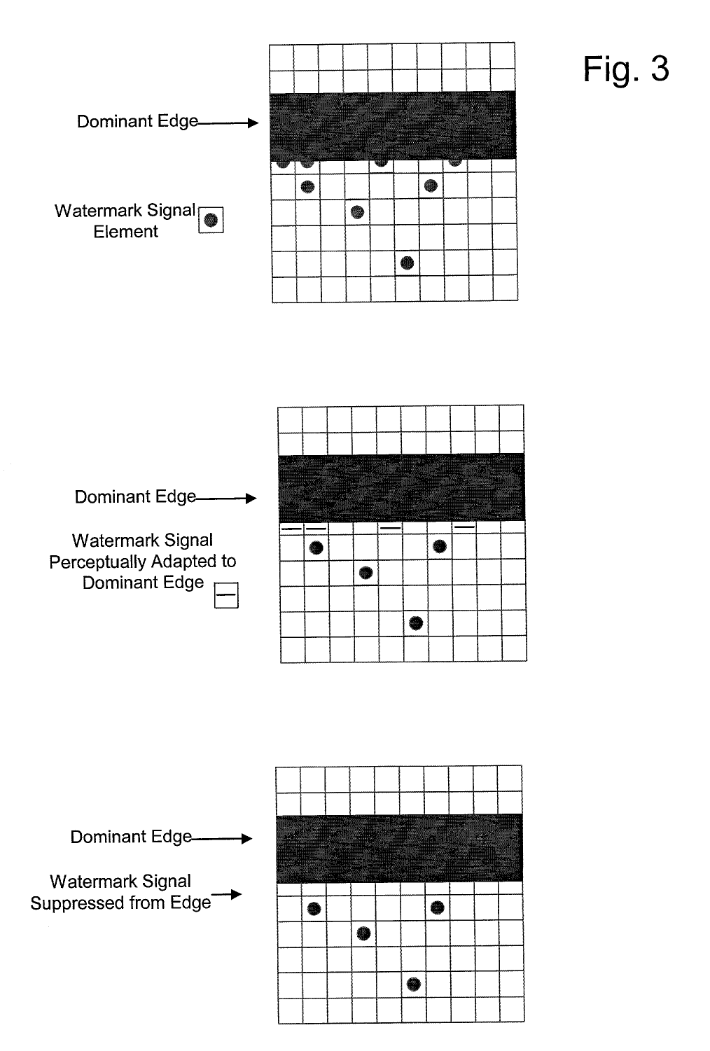

FIG. 3 illustrates an example showing how directionality based perceptual modeling reduces visibility of the digital watermark signal along image edge features. The top diagram illustrates a case with no perceptual modeling at edge features. In this case, the watermark signal elements fall along an edge, potentially creating noticeable artifacts due to the break up of the edge. In the middle diagram, the energy of the watermark signal is adapted so that it follows the dominant edge, rather than breaking up the edge with bumps or other discontinuities. This can be achieved, for example, by adapting the frequency domain watermark along the direction of the dominant edge so that it follows the edge rather than conflicting with it. In the bottom diagram, the digital watermark signal elements are suppressed along the edge based on the directionality measure. This bottom figure shows the extreme case where the watermark signal is completely suppressed along the edge. The watermark signal elements may be reduced by a lesser degree, by adjusting the gain applied to them for example, depending on the values of the directionality measure and the local contrast measure as explained above.

Concluding Remarks

Having described and illustrated the principles of the technology with reference to specific implementations, it will be recognized that the technology can be implemented in many other, different, forms. To provide a comprehensive disclosure without unduly lengthening the specification, applicants incorporate by reference the patents and patent applications referenced above.

The methods, processes, and systems described above may be implemented in hardware, software or a combination of hardware and software. For example, the auxiliary data encoding processes may be implemented in a programmable computer or a special purpose digital circuit. Similarly, auxiliary data decoding may be implemented in software, firmware, hardware, or combinations of software, firmware and hardware. The methods and processes described above may be implemented in programs executed from a system's memory (a computer readable medium, such as an electronic, optical or magnetic storage device).

The particular combinations of elements and features in the above-detailed embodiments are exemplary only; the interchanging and substitution of these teachings with other teachings in this and the incorporated-by-reference patents/applications are also contemplated.

We claim:

1. A method of perceptually masking a digital watermark signal in an image signal, the method comprising:
computing a plurality of wavelet transforms of the image, each at different angular orientations;
evaluating output of the wavelet transforms to compute a directionality measure of features in the image;
modifying embedding strength of the digital watermark signal according to the directionality measure for locations within the image to minimize perceptibility of the digital watermark in the image signal.

2. A computer readable medium on which is stored software for performing the method of claim 1.

3. The method of claim 1 wherein the evaluating includes computing energies of selected subbands from the wavelet transforms at each orientation, and measuring directionality of edges by evaluating relative energies of the selected subbands at each orientation.

4. The method of claim 1 wherein the computing includes performing applying one or more rotatated wavelet filters to the image signal, where the orientations of the rotated wavelet filters are not aligned with orientation of the image signal.

5. The method of claim 1 wherein the modifying includes reducing strength of a pseudorandom watermark signal along directional edges.

6. The method of claim 1 wherein the modifying includes increasing the strength of the watermark signal to exploit data hiding capability of a directional edge.

7. The method of claim 1 wherein strength of a frequency domain watermark that modifies selected frequency domain coefficients is modified based on the directionality measure to adapt the frequency domain watermark to perceptual attributes of directional image features in the image signal.

8. The method of claim 1 wherein the image signal comprises a video signal.

9. The method of claim 1 wherein the modifying includes calculating a gain vector with elements corresponding to elements of a digital watermark signal, where the gain is used to adjust the amount of modification made to the image signal at locations within the image signal corresponding to the elements of the digital watermark signal.

10. The method of claim 9 wherein the digital watermark signal comprises a pseudorandom texture signal.

11. A physical object carrying an image that has been embedded with a digital watermark using the method of claim 1.

12. A method of perceptually masking a digital watermark signal in an image signal, the method comprising:
performing a wavelet filtering of the image, the wavelet filtering characterizing angular orientations of image features in the image signal;
evaluating output of the wavelet transforms to compute a directionality measure of the image features in the image at locations throughout the image signal;
modifying embedding of the digital watermark signal according to the directionality measure for the locations within the image to minimize perceptibility of the digital watermark in the image signal.

13. The method of claim 12 including:
measuring local contrast within the image signal;
suppressing the digital watermark signal at locations in the image having high contrast and high directionality measure, and increasing the digital watermark signal at locations having a high contrast and low directionality measure.

14. The method of claim 12 including:
embedding a frequency domain watermark signal by modifying frequency coefficients to encode a hidden message signal, and controlling the extent to which the frequency coefficients are modified along an angular orientation based on the directionality measure.

15. A computer readable medium on which is stored software for performing the method of claim 12.

16. A physical object carrying an image that has been embedded with a digital watermark using the method of claim 12.

17. A content based digital watermarking method comprising:
performing a wavelet filtering of an image to determine whether regions within an image have a dominant orientation in a direction;
controlling a digital watermark embedding function in regions with a dominant orientation by modifying the digital watermark signal along the direction of dominant orientation such that the digital watermark is perceptually adapted to the dominant orientation of the image in the regions.

18. The method of claim 17 wherein the digital watermark includes a frequency domain component, and the controlling includes adapting the frequency domain component along the direction of dominant orientation to minimize perceptibility of the digital watermark while enhancing detectability.

19. The method of claim 17 wherein the controlling includes adjusting a digital watermark signal in oriented texture regions that are identified as having a dominant orientation.

20. The method of claim 17 wherein the wavelet filtering includes performing a rotated wavelet transform.
